(19) United States
(12) Patent Application Publication
(10) Pub. No.: US 2004/0163768 A1
(43) Pub. Date: Aug. 26, 2004

(54) Method and means for pre-applying an adhesive to a substrate

(76) Inventors: James W. Nowicki, Hopewell, NJ (US); Lie-Zhong Gong, Bridgewater, NJ (US)

Correspondence Address: Cynthia L. Foulke, NATIONAL STARCH AND CHEMICAL COMPANY, 10 Finderne Avenue, Bridgewater, NJ, 08807-0500, US

(21) Appl. No.: 10/371,669

(22) Filed: Feb. 22, 2003

(51) Int. Cl. B05D 5/10; B32B 31/24

(52) U.S. Cl. 156/379.6; 427/207.1

(57) ABSTRACT

A converting machine comprising a means for depositing a reactivatable adhesive onto a predetermined location of a stock material.

### FIELD OF THE INVENTION

The invention relates to methods for applying a reactivatable adhesive to a substrate. The adhesive may be advantageously applied to the substrate during the conversion process, e.g., during the manufacture of a carton blank used in a packaging machine.

### BACKGROUND OF THE INVENTION

Adhesives are widely used for various commercial applications. Hot melt adhesives, for example, are commonly used in product assembly and packaging applications, including cardboard case sealing and carton closing operations. Such hot melt adhesives are applied to a substrate while in its molten state and cooled to harden the adhesive layer.

In the conventional case and carton packaging process for food and consumer goods, the boxes are first filled with food or consumer goods, then a hot melt adhesive is applied to the flap of boxes on the packaging line and compression is exerted to seal the boxes. While this process works reasonably well, it requires the packaging company to devote a tremendous amount of time and attention to adhesive-related issues, including adhesive selection, processing, troubleshooting, inventory, and maintenance of adhesive application equipment. First, selection of an adhesive having the required adhesion, setting speed, and open time is a lengthy process. Then the adhesive needs to be processed in an appropriate way such as melting, transporting, and applying. If anything is wrong with the processing, the boxes will not seal properly, the packaging line must be stopped, and the problem identified and fixed.

Re-activation or heat-sealing of pre-applied adhesives is known and practiced in the art. Heat sealed closures and seams are commonly used in the manufacture of bags, whereby adhesive is coated on the inside of the bag seam and subsequently sandwiched under intense heat and pressure using heated platens or bars. This direct application of heat and pressure renders the adhesive molten, after which a bond is formed. This application benefits from the ability to apply steady direct pressure to ensure intimate contact and sufficient wetting of the adhesive layer to the substrate. This process cannot be used for applications where high pressure for closing is not available, such as in case and carton packaging processes. While focused hot air has been used in the reactivation of pre-applied adhesives used in case and carton sealing operations, this method requires extremely large amounts of energy and can result in undesired heating of the substrate or package, its contents, and the surrounding area and equipment. Moreover, line speed is slow

A need exists in the art for a packaging materials useful in the manufacture of case and cartons whereby the case or carton to be filled is provided to the packager with adhesive already applied to the case or carton and later, during the packaging process, re-activated in order to close or seal the case or carton. The current invention addresses this need.

### SUMMARY OF THE INVENTION

The invention provides a packaging material having disposed thereon a predetermined amount of an adhesive capable of being activated upon exposure to short durations of radiant energy and to methods of depositing the adhesive onto the substrate.

One aspect of the invention comprises a converting machine adapted to apply an adhesive to a predetermined location of a packaging material.

Another aspect of the invention relates to a stock material comprising at predetermined locations thereof a reactivatable adhesive. The adhesive may be applied at predetermined locations of a front and/or a back side surface of said stock material. Preferred stock materials include paperboard stock, plastic stock material, coated paperboard stock material, e.g., stock material having a thermoplastic and/or thermoset coating on at least the front or the backside surface thereof. Also included are rolls of substrate stock material comprising at predetermined locations thereof a reactivatable adhesive. Also included are preformed blanks having at predetermined locations thereof a reactivatable adhesive.

Still another aspect of the invention is directed to a converting machine comprising a means for depositing a reactivatable adhesive onto predetermined location of a stock material. Machines encompassed by the invention will generally comprise a frame, conversion assemblies for converting stock material into a continuous strip of product, a feeding assembly for feeding the stock material through the conversion assemblies, and a cutting assembly which cuts the continuous strip of product into a section of desired length and or shape. A printing station for printing design patterns and ingredient information and the like will preferably comprise part of the conversion assembly. In one embodiment, the means for applying the adhesive will be present at the print station.

Yet another aspect of the invention is directed to a machine comprising means for forming a packaging blank having at predetermined locations a reactivatable adhesive. Included are machines comprising means for forming a flat, folded packaging blank having at predetermined locations a reactivatable adhesive. In preferred embodiments the adhesive will comprise an energy absorbing adhesive, near infrared absorbing ingredients being particularly preferred.

The invention also relates to carton blanks, including flat, folded carton blanks having applied on at least one substrate surface thereof an adhesive capable of being activated upon exposure to short durations of radiant energy, wherein the adhesive is applied during the converting process. Preferable, the adhesive is applied using a slot coater. In one embodiment, the adhesive is applied using a jet printer during the printing of the carton.

The adhesive applied to the case or carton preferably comprises an effective amount of an energy-absorbing ingredient such that upon exposure of the adhesive to radiant energy, the adhesive is activated. The energy-absorbing ingredient selected for use may be dissolved and/or dispersed within the adhesive composition. Organic dyes and/or pigments are particularly useful energy-absorbing ingredients for use in the practice of the invention. Adhesives comprising carbon black and/or NIR absorbing dyes are particularly preferred for use in the practice of the invention. Upon exposure to radiant energy, the adhesive melts to the extent that it is capable of bonding the substrate surface to a second substrate surface.

### BRIEF DESCRIPTION OF THE DRAWING FIGURES

Drawing FIGS. 1-4 illustrate several types of packaging having adhesive pre-applied to the substrate surface thereof.

FIGS. 1 and 2 illustrate typical form, fill and seal embodiments of the invention.

FIG. 3 illustrates a typical Bliss box package.

FIG. 4 illustrates a typical wrap around package.

### DETAILED DESCRIPTION OF THE INVENTION

Paper, paperboard and corrugated paperboard materials can be used to manufacture various types of packages such as bags, Bliss box packaging, clam shell type enclosures, tubs, tray, wrap around packaging, etc. These packaging products are designed to house a variety of consumer goods including but not limited to pharmaceuticals, cosmetics and the like.

The terms stock and substrates are used interchangeable herein.

Packages or containers are used interchangeably herein and include cartons, cases, trays, bags, boxes and the like. I.e., anything used to package a consumer goods such as food and beverages, pharmaceuticals, cosmetics, breakfast cereals, beverage containers (e.g., beer bottles and the like), bakery items, dry foods (e.g., dog food), produce, household products, paper products, soaps and detergents, candy, wet food, frozen food, diapers and the like, and hard goods such as but not limited to tools, fasteners, automotive parts, and light bulbs.

While the term case is generally used in the art to refer to outer shipping containers typically made of corrugated paperboard and the term carton is generally used in the art to refer to a container typically manufactured from solid fiber (e.g., a cereal box), the invention will refer herein generally to the manufacture of a “carton.” It is to be understood however that the invention is not to be so limited.

Preferred packaging materials are rigid or semirigid cellulosic material, including chipboard, boxboard, paperboard or cardboard materials. Cellulosic materials such as a paperboard, boxboard, cardboard and chipboard consists of relatively thick (compared with paper), sheet materials that are comprised of bonded, small discrete fibers comprising cellulose. In addition to cellulose fibers, synthetic fibers such as polyester, polypropylene, polyethylene, polyamide, and nylon fibers, as well as chemically modified cellulosic fibers such as rayon, cellulose acetate, and other cellulose ester fibers may be used in the manufacture of sheet materials used in the manufacturing of packaging materials.

To form a cellulosic sheet, fiber is formed into a rough web or sheet on a fine screen (i.e., a foraminous screen) from a water suspension or dispersion of fiber and is combined with fiber additives, pigments, binder material, secondary binder materials or other components. After the sheet is formed on a fine screen, the rough sheet is then dried, calendared and further processed to result in a finished sheet having a controlled thickness, improved surface quality, one or more coating layers, a fixed moisture content, etc.

Multi-ply paperboard mats are commonly prepared from one or more aqueous slurries of cellulosic fibers concurrently or sequentially laid onto a moving foraminous screen. Conventionally, a first ply is formed by dispensing the aqueous slurry of cellulosic fibers onto a long horizontal fourdrinier wire. Water drains from the slurry through the fourdrinier wire usually aided by application of a vacuum thereunder and additional plies are successively laid on the first and dewatered in similar manner. Alternatively, additional plies may be formed by means of smaller secondary fourdrinier wires situated above primary wire with additional aqueous slurries of cellulosic fibers deposited on each smaller secondary fourdrinier wire. Dewatering of the additional plies laid down on the secondary fourdrinier wires is accomplished by drainage through the wires usually with the aid of vacuum boxes associated with each fourdrinier machine. The additional plies so formed are successively transferred onto the first and succeeding plies to build up a multi-ply mat. After each transfer, consolidation of the plies must be provided to bond the plies into a consolidated multi-ply mat.

Particularly useful and preferred packaging materials comprise paperboard laminate. Preferred laminates comprise a paperboard stock material having a thermoplastic coating on one or both sides. Layers of thermoplastic polymers can be used on either the product or exterior side of the cellulosic web. Thermoplastic materials can be formed into barrier film using a variety of processes including paperboard web extrusion coatings, blown thermoplastic extrusion, linear biaxially oriented film extrusion and by casting from molten thermoplastic resin, monomer or polymer (aqueous or organic solvent) dispersion. These methods are well known manufacturing procedures and will not be described in detail herein. Further composite materials may include chipboard laminated to an aluminum foil which is further laminated to film materials such as polyethylene, Mylar, polypropylene, polyvinylidene chloride, ethylene vinyl acetate and various other types of films. Additionally, these film materials also may be bonded directly to chipboard or kraft. The aforementioned substrates by no means represent an exhaustive list, as a tremendous variety of substrates, especially composite materials, find utility in the packaging industry.

Paperboard useful in the practice of the invention also includes corrugated paperboard materials. Corrugated paperboard is typically made by first manufacturing a single faced structure comprising a fluted medium adherently attached to a top liner making a single faced board (one flat layer bonded to a corrugated sheet). In manufacturing the single faced material, the web is first corrugated and then combined with the liner board using commonly available starch-based corrugating adhesives. Once combined in the single facer, the corrugated material and the liner are permitted to bond and dry. After the single facer is complete, it is then bonded to a second liner using a similar corrugating adhesive material. To make double wall board or further layers of corrugated paperboard, similar process steps are repeated until a sufficient number of layers are complete for the desired application.

After sheet formation the paperboard can be further coated, embossed, printed or further processed before rolling and distribution. Finished paperboard cartons, which will typically comprise inks, overprint varnishes and plastics, are conventionally fabricated from a blank composed of a paperboard substrate which, as described above, may desirably be coated, e.g., with a thermoplastic polymer or a thermoset such as a UV curable coating, on the interior and/or exterior surfaces.

To fabricate a blank, a large web of coated paperboard is printed upon, scored to create the crease or fold lines, and then cut into the individual carton blanks. Packaging blanks may have a core layer of paper pr paperboard, a barrier layer, an inner product contact layer (e.g. low density polyethylene (LDPE)) and an outer thermoplastic material layer (e.g., LDPE). The blanks are then fed into a packaging machine and formed, filled and sealed to create the finished product.

A typical carton converting machine is adapted to receive a paperboard stock in roll form and to unwind same in a continuous moving web, to score same in order to facilitate folding at a predetermined location during erection of the cartons, and finally to cut and separate individual blanks from the web. Typically, the substrate has been printed or decorated prior to die cutting and scoring.

After the blanks have been cut from the sheet or web and leave the carton converting machine, the blanks may, depending on the design, continue to a side seam sealing machine and be put into a side seam blank former. This will cause the inside surface portion of the container that is located along an outer free edge to come in contact with the outside surface of the side seam flap. The contacting areas will then be secured or sealed in some manner to each other. Sealing may be accomplished by the application of a suitable adhesive or by heat sealing the thermoplastic layers together.

The present invention is directed to a converting system whereby adhesive required to form the finished package and to accomplish packaging of an article, is applied at some step during the converting process.

Reactivation, as this term is used herein, refers to an adhesive that resides on at least a portion of at least one substrate to be bonded. In the context of a hot melt adhesive, the adhesive has been applied to a substrate in the molten state and allowed to cool, i.e., solidify, thereon. The adhesive present on the substrate is thereafter reactivated or heated to a molten state, brought in contact with a second substrate and allowed to cool or solidify, thereby bonding the two substrate together. The application of the adhesive onto a substrate for later activation or “reactivation” is referred to herein, and in the art as a “pre-applied” adhesive.

The reactivation efficiency of an adhesive refers to the ability of the adhesive to reactive, e.g., become molten in a short period of time. Reactivation efficiency will depend on the power of the device and the distance of the energy source from the adhesive. Reactivation time depends on receptivity of the adhesive, which depends on the coating weight or thickness of the adhesive and the energy flux density that the radiant source can supply to the adhesive (e.g., intensity per unit area). Energy flux density refers to the distance, focal point, power and intensity of the lamp or power source.

Preferably, the reactivatable adhesives are formulated to reactivate to a temperature of at least about 200° F., more preferably to a temperature of at least about 250° F., upon exposure of less than about 1200 watts/sq inch of near infrared energy for a period of less that about 10 seconds, more preferably less than about 5 seconds, even more preferably less than about 3 seconds.

The selection and method of applying the adhesive is not critical to the practice of the invention, as long as the adhesive can be reactivated. The type of adhesive that can be reactivated in accordance with the invention is not particularly limiting or critical to the practice of the invention. Reactivatable adhesives encompassed by the invention include but are not limited to hot melt adhesives, waterborne adhesives, solvent borne adhesives, moisture curable adhesives, ultraviolet curable adhesives, blocked urethane systems, epoxy based adhesives, and adhesives comprising an encapsulated cureative or the like. Thermoplastic and hot melt adhesives are particularly useful when formulated for pre-application and subsequent later reactivation. It will be appreciated that a thermoplastic adhesive present on a substrate may be applied to a substrate in the form of a waterborne emulsion or solution.

Adhesives reactivatable by application of a NIR energy source and adhesives reactivatable by application of ultrasonic waves are particularly preferred for use in the practice of the invention.

It has been discovered that when a suitable energy-absorbing ingredient is added to a conventional adhesive, reactivation upon short duration of radiant energy can be achieved. Energy-absorbing ingredients contemplated for use in the practice of the invention are commercially available and include, but are not limited to dyes, pigments and fillers. Examples include carbon black, graphite, Solvent Red (2′,3-dimethyl-4-(2-hydroxy-naphthylazo)azo-benzene), Solvent Green, dyes such as Forest Green and Royal Blue masterbatch dye available from Clariant, cyanine-based dyes, oxides such as such as titanium dioxide, and metals such as antimony, tetrakis)dialkylaminophenyl)aminium dyes, cyanine dyes, squarylium dyes and the like.

Pigments, such as carbon black and graphite, are particulate in nature and will usually have somewhat of a spherical shape with average particle sizes in the range of about 0.01 to about 7 microns. Pigment particles aggregate, so aggregate size will be larger. The pigment aggregate size in hot melt adhesives will preferably be smaller than about 500 microns. Aggregate sizes of less than about 100 microns are preferred, more preferably smaller than about 50 microns.

A wide variety of organic NIR triggers are described in the literature and are available for use in the practice of the invention. Such compounds include cyanine, metal complexes, quinone, azo, radical multiphenylmethane, perylene, aromatic annulenes, and fluorenylium. Such triggers possess various absorption characteristics. For example, halogen substituted 1,4,5,8-tetraanilioanthraquinones have excellent transmittance in the vicinity of 860 nm and can absorb NIR in other ranges. Another example is squaraine, which is characterized by intense narrow absorption bands at relatively long wavelength. Also specifically designed phthalocyanine compounds have been demonstrated exhibiting high transmittance to visible light and offering high efficient cut of near infrared.

Preferred energy-absorbing ingredients for use in the practice of the invention are broad band near IR absorbers such as Epolight 1125 (Epolene, Inc), SDA6248 (H. W. Sands Corp.), SDA2072 (H. W. Sands Corp.) and carbon black. Carbon black can be purchased from Cabot under trade name of Monarch, Regal, Black Pearl, and Elftex, or Degussa (FW series), or from Columbian Chemical Company (Raven Series). Carbon black can be manufactured by different methods such as the furnace black method, the gas (channel) black method, and the lamp black method. The key parameters affecting the radian energy absorption of carbon black prepared by these various methods are average primary particle size, surface chemistry and aggregate structure.

Energy absorbing ingredients for use in the practice of the invention will typically have an absorption in the range of from about 400 nm to about 100,000 nM, more preferably from about 700 nm to about 10,000 nm, even more preferably from about 750 nm to about 5000 nm.

Suitable energy-absorbing ingredients for use in reactivatable adhesives of the invention may be identified by blending any desired adhesive with a chosen additive of various particle size and various amounts. Any conventional method of blending the energy-absorbing ingredient with the adhesive such as through use of a paddle mixer or high shear rotor stator mixer such as Ross ME-100LC extruder, as would be apparent to the skilled practitioner, may be used to prepare the adhesive compositions of the invention. The starting adhesive and the adhesive containing the energy-absorbing ingredient then are compared by heating samples of each with a light from a radiant heat source. The samples are tested for reactivation efficiency and bonding performance. Reactivation efficiency is the ability the adhesive to become molten in a short period of time. Suitable additives are those that reactivate quickly and exhibit acceptable bond strength.

Preferred are thermoplastic adhesives which, when pre-applied to a substrate, re-activates with a short duration of exposure to radiant energy, preferably less that about 10 seconds, more preferably less than about 5 seconds, even more preferably less than about 3 seconds, and provides acceptable bond force after a short period of compression or cooling, preferably a period of less that about 30 seconds, more preferably less than about 15 seconds.

Paperboard stock is used broadly herein to encompass paperboard, multiply paperboard, and laminated paperboard (e.g., laminated with a thermoplastic coating or the like). In the manufacture of paperboard, sheets are typically rolled on to large spools or rolls or cut into sheets and stacked on a pallet and stored until needed. Thereafter, the stacked or rolled sheets may be cut and formed into the desired article of manufacture.

Conventional converting machines that convert sheet-like stock material into a packaging blank will generally include a frame having an upstream end and a downstream end, conversion assemblies, mounted on the frame, which converts the sheet-like stock material into a continuous strip of product, a feeding assembly, mounted on the frame, for feeding the stock material through the conversion assemblies, a cutting assembly, mounted on the frame downstream of the conversion assemblies which cuts the continuous strip into a section of a desired length and/or shape. Typically such machines will be automated and/computerized to detect improper operation of e.g., the feeding or cutting assembly. Even more typically, the assembly lines are automated and are operated and controlled by a computer system.

During the conversion process, the sheets can be printed, coated, laminated, layered, crimped, creped, stretched, stamped, convoluted, spiral wound, pressed, folded, fluted, corrugated, and glued to form a variety of articles. In some cases, it may be advantageous during the manufacturing process to score, score cut, or perforate the sheet to aid in forming a bend or hinge at a predetermined location within the sheet. The score can be pressed into the surface of the sheet any time after it has been formed; that is, the score can be pressed into the sheet while in the rolled state, or after it has been cut into the size requires for a particular product. The time and location of the placement of a score, score cut, or perforation will depend upon the desired purpose of the score and the properties of the particular sheet in question.

In the process of the invention, a reactivatable adhesive will be deposited on the paperboard stock at predetermined locations. In preferred embodiments such predetermined location will be at a site of carton closure, e.g., on at least one end flap location. The adhesive may be applied to the roll or to the cut blank. It may be applied to the blank in the unfolded or folded state. The reactivatable adhesive may be applied during the printing stage or during the side sealing stage.

The converting and/or carton blank forming process and apparatus of the invention comprises at least one station or location where adhesive capable of reactivation upon short exposure to radiant energy is applied to the carton substrate. The particular location of the pre-application of adhesive and the type of reactivatable adhesive applied to the substrate is not critical to the practice of the invention.

The site of pre-application of adhesive and the type of reactivatable adhesive applied will depend on the article of manufacture and the end user equipment (e.g., if the carton blanks are being manufactured for use on a packing machine equipped with near infrared energy source, an ultrasonic energy source or some other source of radiant energy).

Depending on the characteristics of the adhesive to be applied to the substrate surface, the paperboard laminated stock material used to form paperboard products such as carton blanks or the like may be manufactured with the thermoplastic coating lacking from those certain predetermined locations where adhesive is to be pre-applied and/or where contact with the reactivated adhesive will be made during the subsequent sealing of the carton.

For casemaking applications, the adhesive may be applied to the roll of paperboard or applied to the cover stock. For core and tube winding applications, the reactivatable adhesive may be applied prior to rolling the stock material or just prior to the tube formation. In case and carton operations, e.g., folding cartons and the like, the adhesive may be applied prior to the rolling of the stock material, when the stock is printed (last stage of printing or sometime during the printing process), after the blanks have been cut or during the cutting of the blanks (e.g., rotory die cutter, pattern die cutter). As noted above, the adhesive may be applied at the printing stage. Use of an ink jet for the pre-application of the reactivatable adhesive is particularly advantageous.

The invention provides an improvement in the art whereby packaging material may be provided to the packager with adhesive already applied to the packaging stock (e.g., to the flat folded cartons supplied to the packager). As such packagers can avoid dealing with adhesives and the issues associated with the application of adhesives on the packaging line.

In addition to forming the side seal, the packaging manufacturer (converter) applies to at least one predetermined location a predetermined amount of adhesive sufficient to seal the container. The adhesive applied to the carton blank comprises an energy-absorbing ingredient. By including an energy-absorbing ingredient, the absorption, reflection and transmission characteristics of the adhesive composition is tailored so as to optimize the composition's re-activation and subsequent bond formation. The adhesive is applied to the substrate and, depending on the type of adhesive applied, allowed to dry or solidify. Such adhesives are capable of reactivating upon short duration of exposure to radiant energy, preferably less that about 10 seconds, more preferably less than about 5 seconds, and provides acceptable bond force after a short period of compression or cooling, preferably a period of less that about 30 seconds, more preferably less than about 15 seconds.

Thus, the flat folded configuration supplied to the packager has all the adhesive elements required to seal the container and the packager can avoid applying adhesive in the packaging line and avoid the problems associated with such application.

It has been discovered that when using a reactivatable adhesive preapplied to a substrate to be sealed or otherwise bonded to a second substrate, that less adhesive may be used to obtain the same bond strength. In contrast to adhesives applied on the packaging line, it has been discovered that adhesive reactivated in accordance with the invention have improved performance properties. Moreover less adhesive is required to be used when pre-applied than when applied on the line. Carton blanks used in the practice of the invention will typically be coated with from about 0.5 mil to about 15 mil of adhesive. The adhesive present on the carton blank reactivates upon exposure to short durations of radiant energy and provide superior on-line performance and set speed which allows for quicker production speeds.

By modifying the placement of adhesive on the substrate (e.g., top or bottom end flap, vertical side section), the size or surface area, the shape and/or pattern of the adhesive applied to the substrate, packaging may be designed to control the amount of force required to open a sealed package, i.e., control the ease of opening. Thus packaging can be designed that is child proof or, alternatively, geriatrically friendly. The adhesive formulations of the invention may be pre-applied in a continuous or discontinuous, e.g., as evenly spaced beads or dots, manner depending on surface area and coating weight desired. Particular patterns may be used to optimize substrate/adhesive contact. Depending on the adhesive, the bead size, thickness, distance apart and pattern will vary.

The adhesive may be pre-applied to the substrate by any method known in the art, and include, without limitation roll coating, painting, dry-brushing, dip coating spraying, slot-coating, swirl spraying, printing (e.g., ink jet printing), flexographic, extrusion, atomized spraying, gravure (pattern wheel transfer), electrostatic, vapor deposition, fiberization and/or screen printing. In a particularly preferred embodiment, the adhesive is applied to a slot coater through a control mechanism controlled by a high speed controller such as the Nordson speed coat applicator module with controller.

The method of pre-application to the substrate is not critical to the practice of the invention, but may be selected depending on the packaging design or like consideration.

In addition, the process of the invention is cost effective and enables the use of many packaging designs that could not heretofore be used with prior art packaging systems. Adhesive may be placed and packages designed to be tamper resistant/tamper evident. Specifically, problems associated with adhesive stringing and adhesive “ooze out” or “squeeze out” upon sealing/compression operations encounter in prior art packages and packaging processes that apply glue on the line are avoided when using reactivatable adhesives. Using the process of the invention, packaging materials such as carton blanks can be manufactured that use less paperboard stock. As such, the reactivatable adhesives of the invention may be precisely preapplied to the area to be sealed. The area of adhesive application can be located closer to the distal portion of an end flap to be sealed. Adhesive may be applied within 2 mm of the edge of the substrate. This advantage means substantially savings in the amount of packaging materials needed (i.e., the end flap may be smaller). The areas of adhesive may also be placed closer to the fold line, enabling the use of a lighter weight paperboard substrate stock, which also results in a substantial cost savings.

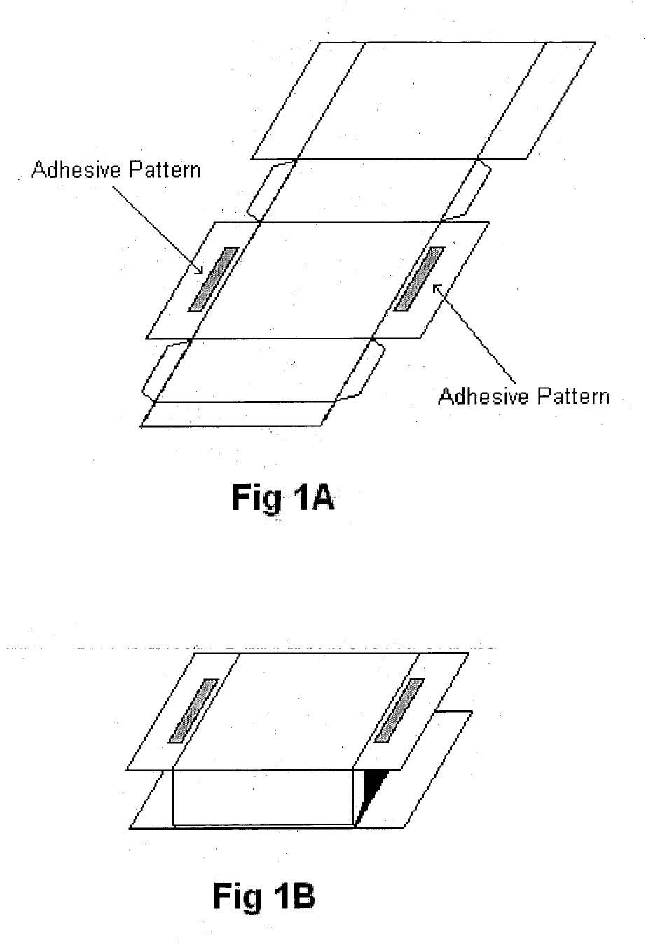

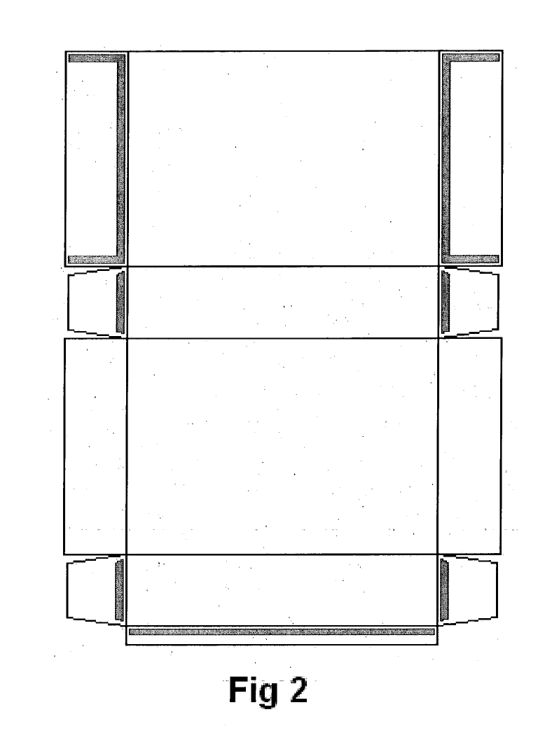

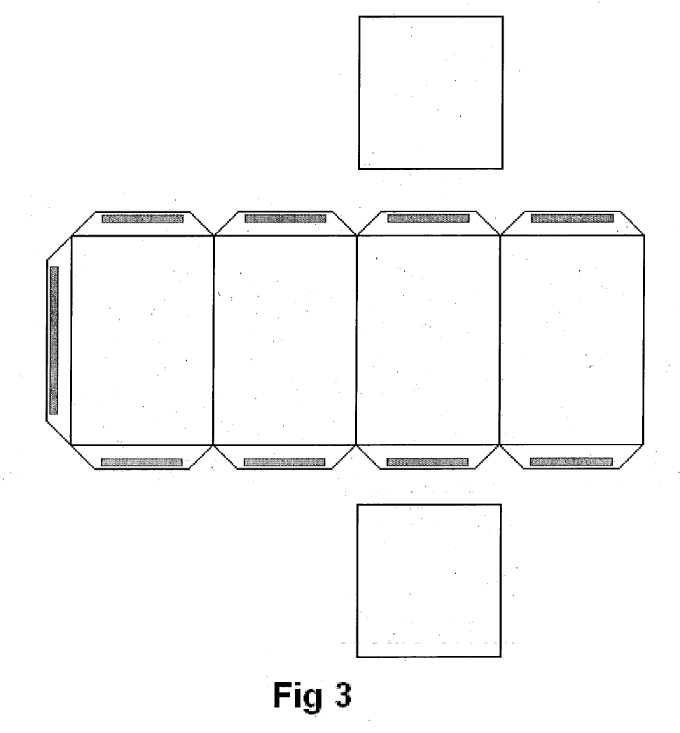

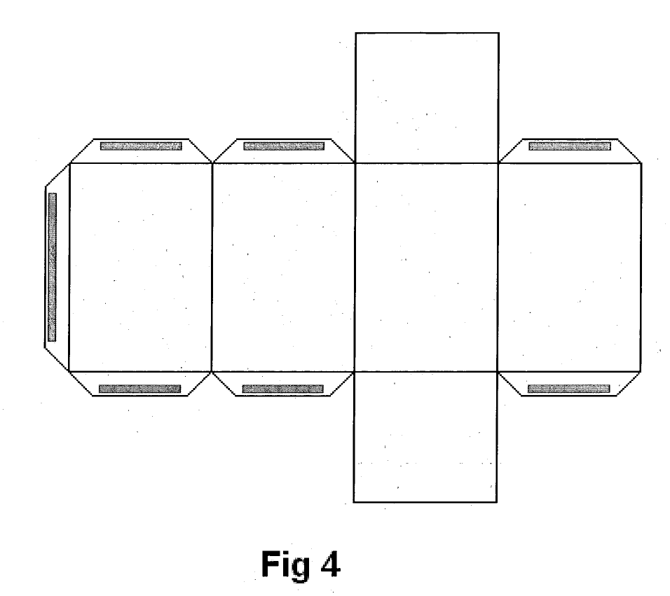

Drawing FIGS. 1-4 illustrate several types of packaging encompassed by the invention. FIGS. 1 and 2 illustrate typical form, fill and seal embodiments of the invention. FIG. 1A shows a flat carton blank having reactivatable adhesive applied to the one flap of each set of end flaps. FIG. 1B shows the formed carton. FIG. 2 shows a flat form, fill and seal type carton having reactivatable adhesive applied to various end flaps. This box is designed to be sift proof and tamper proof. Sift proof boxes have an additional advantage that use of secondary packaging material (e.g., the bag within the cereal carton) can be avoided. FIG. 3 illustrates a typical Bliss box package. It will be appreciated that adhesive may, alternatively be placed on the two end panels. FIG. 4 illustrates a typical wrap around package. Many other packaging designs as will be apparent to one skilled in the art are encompassed by the invention.

The type of adhesive that can be reactivated in accordance with the invention is not particularly limiting or critical to the practice of the invention. Thermoplastic and hot melt adhesives formulated for pre-application and subsequent later reactivation are particularly useful for case and carton sealing. Other types of adhesives such as and without limitation, waterborne adhesives, epoxys and reactive urethanes, may be used. Water-based reactivatable adhesives are particularly useful in application to substrates to be use in core and tube winding operations.

Any conventional polymers suitable for use in formulating adhesives, as are well known to those skilled in the art, may be used in the practice of the invention. Typical hot melt adhesive formulations to which the additive of the invention may be added comprise a wax or diluent, a thermoplastic polymer and a tackifier. The adhesive may be formulated with tackifying resins, plasticizers, waxes and/or other conventional additives such as antioxidants and stabilizers in varying amounts as are known to those skilled in the art and as required for particular formulations.

The adhesives useful in the practice of the invention adhesives may be prepared using techniques known in the art. For example, hot melt adhesive compositions are prepared by blending the components in the melt at a temperature of about 100° to 200° C. until a homogeneous blend is obtained, usually about two hours. Various methods of blending are known and any method that produces a homogeneous blend is satisfactory. Method of preparing adhesives are well know in the art and will not be discuss further herein. The energy-absorbing ingredient may be added, with stirring, any time during the preparation of the base adhesive, or following preparation of the base adhesive. The amount added will depend on the type of additive the size and the dissolution or dispersion properties. The additive is added in an amount effective to reactivate (melt) the adhesive upon exposure to short durations (typically less that 10 seconds) of radiant energy. Typically, the additive will be present in an amount of about 0.001 to about 10 parts per 100 parts of the adhesive composition.

Reactivatable adhesives containing an energy-absorbing ingredient are described in copending commonly assigned U.S. application Ser. No. 09/933,279, entitled “Reactivatable adhesives” and in commonly assigned and concurrently filed application Ser. No. ______ (ATTY docket No. 2090), entitled “Reactivatable adhesive,” the disclosures of which are incorporated herein in their entireties by reference.

Adhesives reactivatable by the application of ultrasonic waves are described in commonly assigned and concurrently filed application Ser. No. ______ (ATTY docket No. 2091), entitled “Reactivation of pre-applied adhesives by ultrasonic waves,” the disclosure of which is incorporated herein in its entirety by reference.

In embodiments where the adhesive is sensitive to ultrasonic waves the invention involves bringing one substrate in contact with the adhesive present on a second substrate, subjecting the first and/or second substrate to ultrasonic compression for a time sufficient to melt/reactivated the adhesive and allowing the adhesive to solidify whereby the first substrate is bonded to the second substrate. In embodiments were reactivation occurs by exposure to ultrasonic energy, the adhesive present on the first substrate may be reactivated either before or after being contacted with the second substrate to be bonded thereto.

The re-activation and performance of ultrasonically reactivatable adhesives is achieved by incorporating into an adhesive an energy-absorbing ingredients that are sensitive to ultrasonic energy. Examples include thermoplastics, thermosets, low Tg polymers, composites and blends thereof.

The reactivation efficiency of an adhesive refers to the ability of the adhesive to reactive, e.g., become molten in a short period of time. Reactivation efficiency will depend on the compression pressure, the power and frequency of the ultrasound, the geometry and contact area of the ultrasonic horn and the exposure time.

Adhesives reactivatable by the application of ultrasonic waves are described in commonly assigned and concurrently filed application Ser. No. ______ (ATTY docket No. 2091), entitled “Reactivation of pre-applied adhesives by ultrasonic waves,” the disclosure of which is incorporated herein in its entirety by reference.

Preferred formulations for the adhesive layer will comprise styrene-butadiene-styrene copolymers, ethylene vinyl acetate, a wax and a tackifier. Elastomeric adhesives with glass transition temperatures below 20° C., or semicrystalline polymers with a melting temperature of below about 20° C. are particularly preferred.

Preferred reactivatable adhesive will reactivate upon exposure to ultrasonic energy having a frequency of from about 15-kilohertz to about 60 kilohertz, more preferably from about 20 kilohertz to about 40 kilohertz. Preferably the reactivatable adhesives are formulated to reactivate to a temperature of at least about 200° F., more preferably to a temperature of at least about 250° F. upon exposure of less than about 2000 watts/sq inch of ultrasonic energy for a period of less that about 10 seconds, more preferably less than about 5 seconds, even more preferably less than about 3 seconds.

Ultrasonic generators used in the practice of the invention generally and conventionally comprise a transducer, a booster and horn. A booster is typically used to amplify and boost energy. Ultrasonic horns are known in the art and include rectangular horns and rotary horns of cylindrical shape. Preferred geometry for use in the practice of the invention is to press the ultrasound horn onto substrate layers where the adhesive layer is sandwiched in the middle. Alternatively, the substrate may be pressed into the horn. The ultrasonic energy will typically be used at a frequency of from about 15 kilohertz to about 60 kilohertz, more preferably from about 20 kilohertz to about 40 kilohertz.

The adhesive is applied to a substrate while in its molten state and cooled to harden the adhesive layer. The adhesive product can be applied to a substrate such as a cardboard substrate, nonwoven article, etc, by a variety of methods including coating or spraying in an amount sufficient to cause the article to adhere to another substrate upon reactivation.

The adhesives of the invention find use in packaging, converting, bookbinding, bag ending and in the nonwovens markets. The adhesives find particular use as case, carton, and tray forming, and as sealing adhesives, including heat sealing applications, for example in the packaging of cereals, cracker and beer products. Encompassed by the invention are containers, e.g., cartons, cases, boxes, bags, trays and the like, wherein the adhesive is applied by the manufacturer thereof prior to shipment to the packager. Following packaging, the container is heat sealed by reactivating the preapplied adhesive using radiant energy.

In the reactivation process, radiant energy can be supplied by a number of sources, as will be apparent to the skilled practitioners. Examples include lasers, a high pressure xenon arc lamp, a coiled tungsten wire, ceramic radiant heater, tungsten-halogen lamps and ultrasonic waves. In a preferred embodiment, radiant energy within the near infra-red (NIR) region is used. Peak wavelengths of from 400 nm to about 100,000 nm may be used. More typically, a peak wavelength of from 700 nm to about 10,000 nm, most typically a peak wavelength of from about 750 nm to about 5000 nm will be used in the practice of the invention. Commercial sources of equipment capably of generating radiant heat required for use in the practice of the invention include Research Inc. (Eden Prairie, Minn.), Chromalox (Ogden, Utah), DRI (Clearwater, Fla.), Advent Electric Inc. (Bridgeport, Pa.), and Glo-Quartz Inc. (Mentor, Ohio). Both coherent and non-coherent sources may be used.

While the adhesive may be applied directly to the carton, it is to be understood that the adhesive to be reactivated during the packaging of the carton may be placed on the carton blank via a transfer tape or the like. Among transfer tapes contemplated for use is a tape comprising a backing material having a first and a second opposing surface. On one surface is disposed, for example, a pressure sensitive adhesive and on the second surface is disposed a reactivatable adhesive. Useful backing material substrates include foam, metal, fabric and various polymer films such as polypropylene, polyamide and polyester. The pressure sensitive adhesive being used to apply the reactivatable adhesive to the surface of the carton prior to or during the packaging and sealing thereof.

The invention is further illustrated by the following non-limiting examples.

### EXAMPLES

### Example 1

The following adhesive samples A-C are examples of adhesives containing, as the energy absorbing ingredient, a pigment or an organic dye. These formulations are particularly well suited for use when e.g. carton blanks are being manufactured for use on a packaging machine equipped with a near infrared energy source as a reactivating means.

Sample A

An adhesive sample was prepared by blending an EVA, paraffin wax, and hydrocarbon tackifier based hot melt adhesive available from National Starch & Chemical Company (Cool-Lok® 34-2125) with 0.3 wt % of carbon black (Regal 400, Cabot) using a paddle mixer.

Sample B

0.5 wt % of Epolight 1125, an NIR absorbing dye available from Epolight, was dissolved homogeneously into the base hot melt adhesive (Cool-Lok 34-2125) and uniformly blended with the adhesive with a paddle mixer.

Sample C

An EVA based waterborne emulsion having the composition comprising 88.0 wt % EVA Emulsion (Dur-o-set E-200, Vinamul), 7.5 wt % Diethylene/Dipropylene Glycol Dibenzoate Plasticizer, 4 wt % water and 0.5 wt % Carbon Black (Plack Pearls 4750, Cabot) was prepared by pre-dispersing the carbon black in the plasticizer using a rotor-stator. The EVA emulsion and water were added using moderate speed axial paddle stirring.

### Example 2

The following adhesive samples D-G are examples of adhesives containing, as the energy absorbing ingredient, a polymer. These formulations are particularly well suited for use when e.g. carton blanks are being manufactured for use on a packaging machine equipped with an ultrasonic energy source as a reactivating means.

Sample D

An ethylene vinyl acetate (EVA) based adhesive available from National Starch and Chemical Company (Product 34-2125). This adhesive contains about 30 wt % of a wax; about 35 wt % of a tackifier; about 35 wt % of EVA polymer; and about 1 wt % of an antioxidant.

Sample E

A styrene-butadiene rubber (SBR) based adhesive available from National Starch and Chemical Company (Product 34-5610). This adhesive contains about 55 wt % tackifier; about 25 wt % SBR polymer; about 20 wt % diluent oil; and about 1 wt % antioxidant.

Sample F

An ethylene vinyl acetate based adhesive available from National Starch and Chemical Company (Product No. 40-1103). This adhesvie contains about 88 wt % EVA base resin, 8 wt % plasticizer, 0.2 wt % surfactant and water.

Sample G

An adhesive comprising about 42 wt % of a neoprene latex base resin, about 42% of a tackifier, about 10% of a styrene butadiene polymer and water (available from National Starch and Chemical Company, Product No. 40-801A).

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A converting machine comprising a means for depositing a reactivatable adhesive onto a predetermined location of a substrate material, said reactivatable adhesive containing a reactivatable ingredient where upon exposure to radiant energy having a peak wavelength of from about 400 nm to about 100,000 nm the adhesive reactivates.

2. The converting machine of claim 1 wherein said reactivatable adhesive reactivates upon exposure to radiant energy having a peak wavelength of from about 700 nm to about 10,000 nm.

3. The converting machine of claim 2 wherein said reactivatable adhesive reactivates upon exposure to radiant energy having a peak wavelength of from about 750 nm to about 5,000 nm.

4. The converting machine of claim 1 wherein said reactivatable adhesive reactivates to a temperature of at least about 200° F. upon exposure of less than about 1200 watts/sq inch of near infrared energy for a period of less that about 10 seconds.

5. The converting machine of claim 1 wherein the substrate is a cellulosic material, a thermoplastic material, a metallic material or a combination thereof.

6. The converting machine of claim 1 wherein the substrate is a plastic material.

7 The converting machine of claim 1 wherein the adhesive is applied by roll coating, slot-coating, swirl spraying, ink jet printing, extrusion, atomized spraying, gravure, fiberization, flexographic printing and/or screen printing.

8. The converting machine of claim 1 wherein said means for depositing said reactivatable adhesive is a slot coater.

9. The converting machine of claim 8 wherein the adhesive is applied to the slot coater through a control mechanism controlled by a high speed controller.

10. The converting machine of claim 1 wherein said means for deposition said reactivatable adhesive applies said adhesive in a discontinuous pattern.

11. The converting machine of claim 1 wherein said means for deposition said reactivatable adhesive applies said adhesive in a continuous pattern.

12. The converting machine of claim 1 comprising a frame, conversion assemblies for converting substrate material into a continuous strip of product, a feeding assembly for feeding the material through the conversion assemblies, and a cutting assembly which cuts the continuous strip of product into a section of desired length and or shape.

13. The converting machine of claim 12 wherein the conversion assemblies include a printing station for printing a predetermined pattern onto the stock material.

14. The converting machine of claim 13 wherein said means for depositing the reactivatable adhesive onto said predetermined location of the stock material is located at said printing station.

15. The converting machine of claim 1 wherein the energy absorbing ingredient is a pigment and/or an organic dye.

16. The converting machine of claim 15 wherein the energy absorbing ingredient is carbon black.

17. The converting machine of claim 1 wherein the reactivatable adhesive is a hot melt adhesive.

18. The converting machine of claim 1 wherein the reactivatable adhesive is a thermoplastic adhesive.

19. The converting machine of claim 18 wherein the reactivatable adhesive is applied to the substrate as a waterborne adhesive.

20. A side seam sealing apparatus comprising means of applying a reactivatable adhesive to a side seam flap and to predetermined other locations of a carton blank or other substrate.

21. A machine comprising means for forming a flat, folded packaging blank having at predetermined locations a reactivatable adhesive.

22. The machine of claim 21 wherein the reactivatable adhesive comprises an energy absorbing adhesive that absorbs radiant energy having a peak wavelength of from about 400 nm to about 100,000.

23 The machine of claim 22 wherein the reactivatable adhesive comprises a near infrared absorbing ingredient.

24. A method of applying a reactivatable adhesive onto a substrate surface said method comprising applying a reactivatable adhesive onto the surface of a substrate by roll coating, slot-coating, swirl spraying, ink jet printing, extrusion, atomized spraying, fiberization, gravure, flexographic printing and/or screen printing

25. The method of claim 24 wherein said adhesive is applied to the substrate in a discontinuous pattern.

26. The method of claim 24 wherein said adhesive is applied to the substrate in a continuous pattern.

27. The method of claim 24 wherein the adhesive is applied within 2 mm of the edge of the substrate.

27. The method of claim 24 wherein the substrate is a plastic substrate.

28. The method of claim 24 wherein the substrate is a cellulosic substrate, a thermoplastic substrate, a metallic substrate, or a combination thereof.

29. The method of claim 28 wherein the substrate is a paper or paperboard substrate.

30. The method of claim 28 wherein said substrate is a carton blank.
